(19) United States
(12) Patent Application Publication
(10) Pub. No.: US 2016/0313168 A1
(43) Pub. Date: Oct. 27, 2016

(54) Ultrasonic Water Flow Detection In Highrise Buildings

(71) Applicant: Donald Benjamin Ogilvie, Toronto (CA)

(72) Inventor: Donald Benjamin Ogilvie, Toronto (CA)

(21) Appl. No.: 15/065,091

(22) Filed: Mar. 9, 2016

Related U.S. Application Data
(60) Provisional application No. 62/152,788, filed on Apr. 24, 2015.

(51) Int. Cl. G01F 23/00; G01F 1/66

(52) U.S. Cl. CPC G01F 23/00; G01F 1/66

(57) ABSTRACT

This system is used to monitor water flow in a multi-resident high rise apartment building with the use of an ultrasonic flow meter and sensor. The non-intrusive process is designed to measure water flow in either a horizontal pipe at the floor level or in a vertical riser pipe. The operational process is designed to solve the problem of continuous unwanted water flow and leaks over a given preset period. For example, a broken faucet or an overflowing toilet are some of the problems affecting stakeholders. This invention embodies water flow from zero to maximum flow in accordance with a scaled 4-20 mA signal to provide early warning to stakeholders with the use of cellular text message. The scaled 4-20 mA signal is fed into a Programmable Logic Controller (PLC) with Human to Man Interface (HMI) to provide live water-flow trend locally and remotely with the use of a web server.

### BACKGROUND OF THE INVENTION

This application is a continuation in part of U.S. utility applications EFS ID 22168525, application No. 62152788, Filed 24 Apr. 2015

### FIELD OF THE INVENTION

The present invention relates to flow measurement in multi-resident high rise buildings, in particular, this invention relates to an automated process for measuring and monitoring water flow and leaks using non-intrusive ultrasonic flow meter.

### THE DESCRIPTION OF THE RELATED ART

There are various water monitoring systems for domestic water flow and leaks in multi-resident dwellings. Most systems install a sensor to a given appliance, such as hot water heaters, air conditioner, and also in individual units in multi resident buildings. These sensors are intrusive to the process which is water. For example, the sensor would come in contact with the water to activate a device which in turn will annunciate a leak condition.

The patents below show various disclosures of the water monitoring process.

U.S. Pat. No. 6,377,190 to Saar is designed to measure the water consumption and the water heat energy use in an individual unit in a multi-unit building so that the individual unit can be assigned responsibility without substantial plumbing infrastructure changes. The invention also relates to monitoring unusual water usage to detect leaks and open valves.

GB Patent No. 2395572 to Kinsey et al relates to flow control monitors and in particular to flow control monitors for use in domestic, commercial or industrial water supply systems. The system may be used to monitor the water supply to a building and to turn off the supply if flow conditions consistent with a leak situation are detected.

CA Patent No. 2765089 to Patel et al describes monitoring pressure transients in a liquid within a liquid distribution system using only a single sensor so that events such as the opening and closing of valves at specific fixtures are readily detected. The sensor, which can readily be coupled to a faucet bib, transmits an output signal to a computing device. Each such event can be identified by the device based by comparing characteristic features of the pressure transient waveform with previously observed characteristic features for events in the system. These characteristic features, which can include the varying pressure, derivative, and real Cepstrum of the pressure transient waveform, can be used to select a specific fixture where a valve open or close event has occurred. Flow to each fixture and leaks in the system can also be determined from the pressure transient signal. A second sensor disposed at a point disparate from the first sensor provides further event information.

CA Patent No. 2600976 A1 to Kates relates to a system and method for electronic utility (e.g., water and gas) metering and leak detection. It describes the system and method for detecting water and/or gas leaks by monitoring usage patterns. In one embodiment, the existence of a leak is detected by looking for usage patterns wherein water or gas is always being used, at least at a low rate. A leak is indicated if usage does not drop to zero, at least for a period of time, during a given time interval (e.g., during a 24-hour period). The severity of the leak is indicated by the minimum amount of usage during the given time period. In one embodiment, the leak detection system is provided in connection with an Automatic Meter Reading (AMR) system.

US2010/0204839 to Behm et al describes a method for monitoring water usage in a home or business through the use of pattern recognition. Wherein the system monitors water flow through a valve and monitors usage over a period of time to determine normal usage. Once a normal pattern of usage is determined the system monitors pattern usage over time and determines if the pattern of usage exceeds cut-offs. In the event the usage exceeds the cut-offs the system produces an alarm and shuts off the valve. Once the cause for the system cut-off has been determined the cause may be corrected and the valve reopened.

U.S. Pat. No. 050,395 A1 to Ervin describes a utility monitoring system, where methods of implementation, and programs are disclosed which can provide real-time information regarding a utility system, such as a water system of a home or building. The monitoring system can detect operating parameters or attributes of one or more sources in the water system and create a user-defined output selected so as to motivate and inspire conservation. For example, the system can output a monetized analysis of the usage of the water system. Further, the system can be configured to provide alarms in response to possible leaks when no period of zero usage is detected and/or in response to operating parameters that exceed a predetermined range of acceptable values. The system can control one or more of the sources in response to an alarm, allowing the system to shutoff or otherwise control the sources in the water system.

The above prior arts measure water leaks using intrusive methods. In addition, they measure water flow and leaks on a single unit or appliance in a multi-resident building. On the other hand, the following examples highlight the differences between this present invention and the prior arts mentioned above:
a) This new utility invention measures the complete floor or floor riser, which is a cost saving measure that uses one flowmeter, and annunciate the results locally at the control panel in a multi-resident high rise building. In addition, a cellular text message is sent to the stakeholder.
b) While this new invention offers field supervision through written ladder logic program and will send a signal to the stakeholders if the flow monitoring signal is missing for more than a given pre-set time, none of the above prior arts offers supervision to monitor field equipment for broken equipment or missing signal to the controller.
c) This new invention uses Human to Man Interface (HMI) to remotely look at the flow and leak condition at the floor level or the floor riser. Furthermore, the HMI process also provide remote supervision for missing field signal(s) from the flow meters in multi-resident high rise buildings. This invention helps to enhance the troubleshooting process of maintaining a robust water leak monitoring system.
d) The prior arts do not provide a regional and or remote Wide Area Network (WAN) to look at common web base hub to perform a central monitoring for multi-resident high rise buildings, while this new invention, provides local, regional and global monitoring for multi-resident high rise buildings with the use of a centralized common hub.
e) This new invention will annunciate a leak or flow condition locally at the control panel when the pre-set prerequisites are met, and will subsequently annunciate another leak in accordance with the amount of floors on the building.

### BRIEF DESCRIPTION OF THE DRAWINGS

FIG. 1 Getting the Al signal to the controller

FIG. 2 Scaling Process

FIG. 3 The complete process in flow diagram

FIG. 4 The flow diagram block layout

FIG. 5 The flow monitoring piping layout for the horizontal take off

FIG. 6 The vertical piper layout

FIG. 7 Transducer or flow meter location for optimum flow measurement

FIG. 8 4-20 mA loop

FIG. 9 Appling power to the transducer or flow meter

FIG. 10 Water flow mounting network-layout

FIG. 11A Example of a Common Building Complex

FIG. 11B Example of Individual Buildings Connected through an Internet Cloud

FIG. 12 A Typical Field Layout of Flow Meters

### DETAILED DESCRIPTION OF THE DRAWINGS:

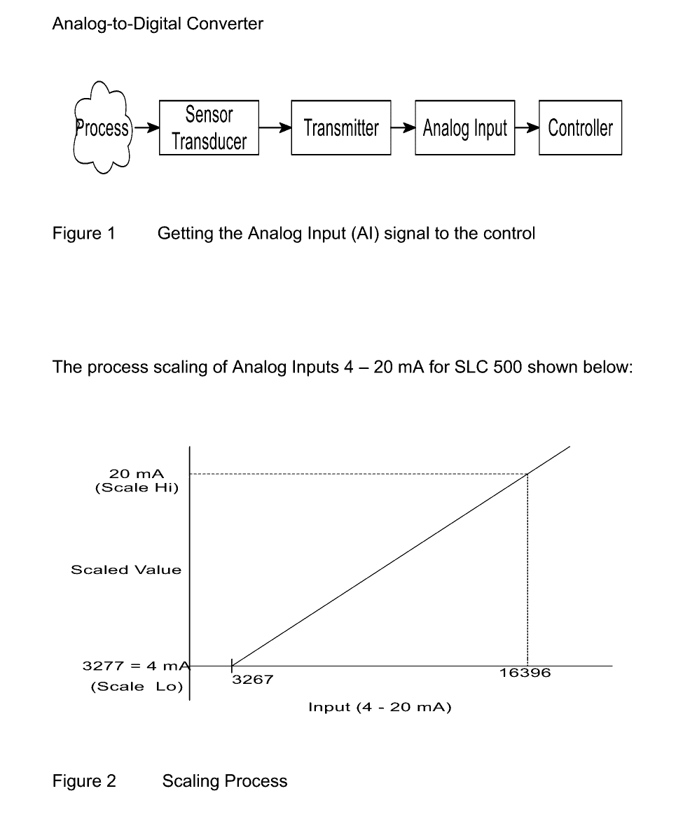

FIG. 1 shows the process of an analog-to-digital converter (ADC) performs the signal conversion in an analog input module. The conversion process divides the input signal into many digital counts which represents the magnitude of the current. This division of the input signal is called resolution.

The A/D breaks down an input signal for 14 bits, i.e. 2¹⁴=16384. This 14 bits process is used in the PLC program as a memory integer in various decision-making processes.

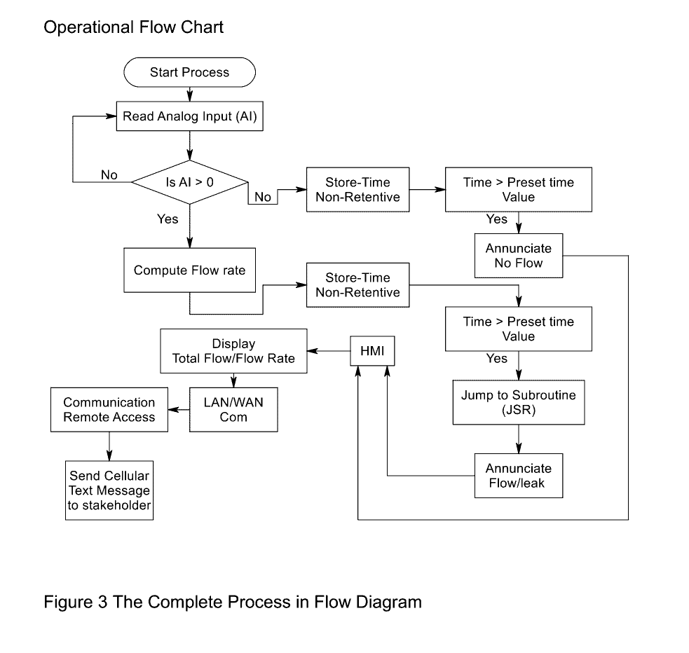

FIG. 2 shows how the data from the field is scaled for programming use. It also shows:
slope=(Y2−Y1)/(X2−X1) where Y2 and Y1=scale maximum and minimum and X2 and X1=input maximum and minimum respectively.
Where scale value=(input value*slope)+offset
The scaling process uses the straight line graph mathematical formula Y=MX+B
Where Y is the output or the engineering units
Where M is the slope or the scale factor
Where X is the input (in milliamp) and
Where B is offset, and can be further defined as scaled minimum−(input minimum*slope)
Using a 4-20 mA signal (Al), the input data is from 3277-16383 shown in the graph above.
The scaled value represents an output proportional to the flow from 0-100%
   Process to annunciate a leak condition:

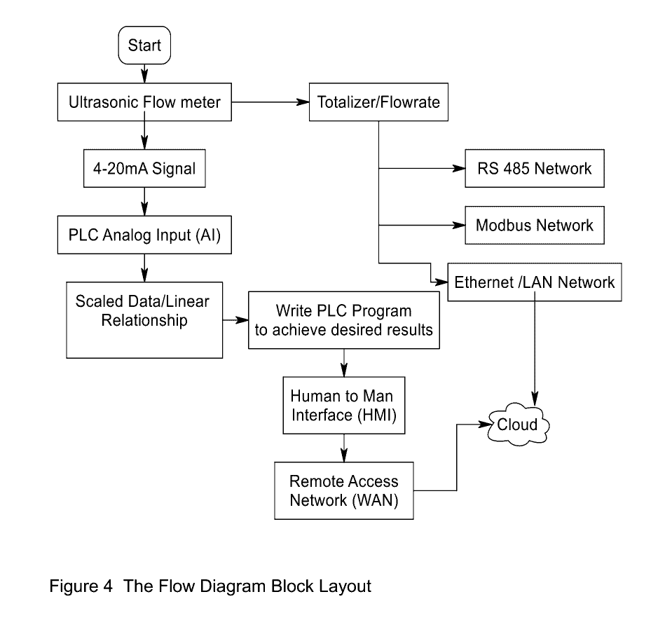

FIG. 3 shows the decision-making process of receiving a signal from the field device as an analog input to compute flow rate, flow duration, and total flow. If the signal is greater than a given integer value over a set time period, then a cellular text will be sent to the stakeholder. If the field signal is absent, then a text message will be sent to notify the stakeholder of a failed field device. This supervisor process of monitoring for failure will send a text annunciating no flow. The subroutine block shows that the program in the PLC is broken down into semi-independent programs which are embedded in a larger main program that executes a specialized control sequence when activated by the main program. This subroutine is a time-driven process that routinely grabs integer data for the purpose of live data trending and graphing.

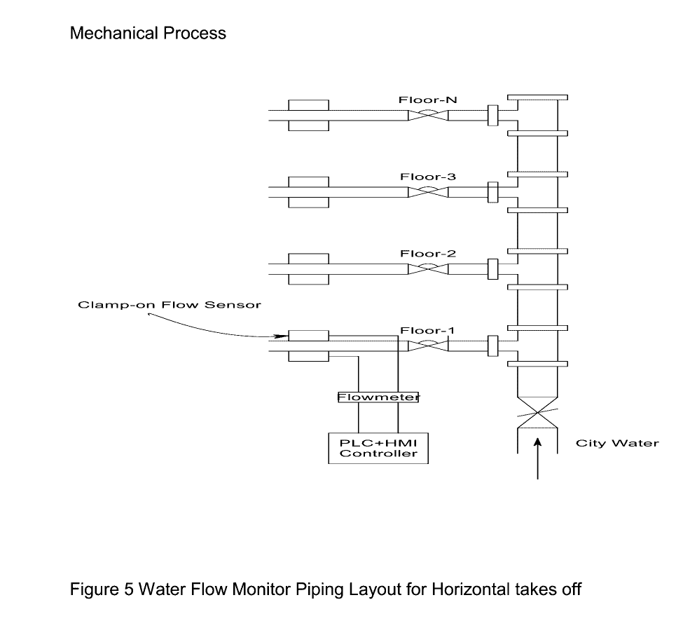

FIG. 4 shows the operational process from the flow meter to the PLC process. The flow meter also provides networking capabilities to support data logging, Ethernet and wide area network (WAN). The data logging process provides added value to the invention process by independently verifying the flow rate and duration. This process allows the utility function to show efficiency, while providing the system with voting options.

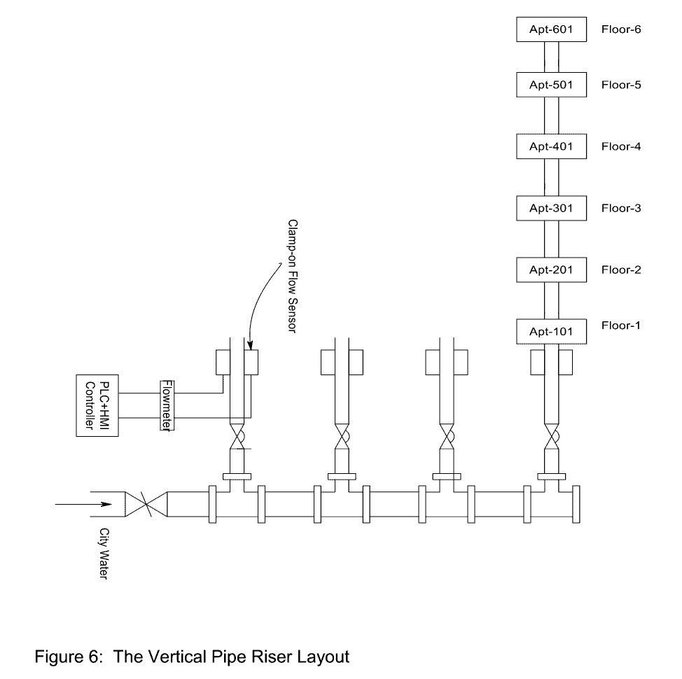

FIG. 5 shows a mechanical layout of the piping system.

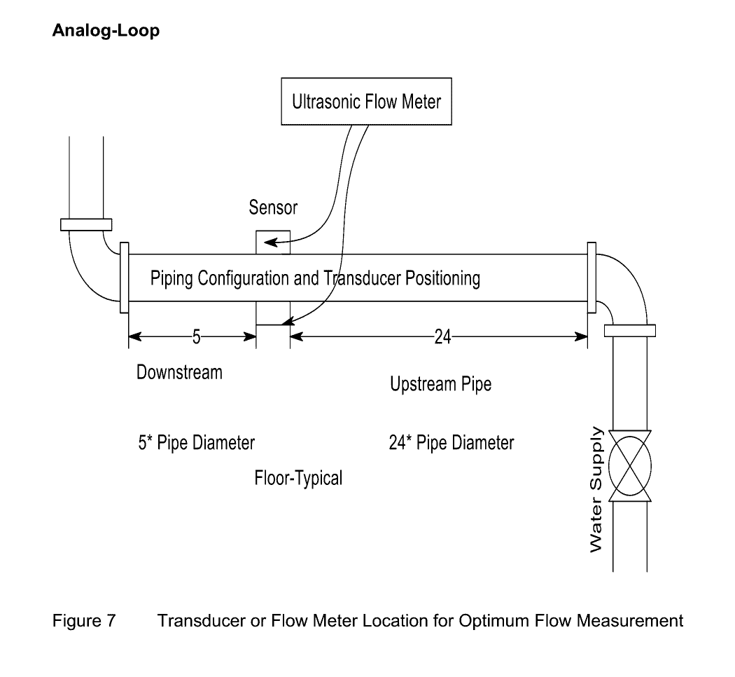

FIG. 6 is a diagram that shows the piping system entering from one apartment to another vertically.

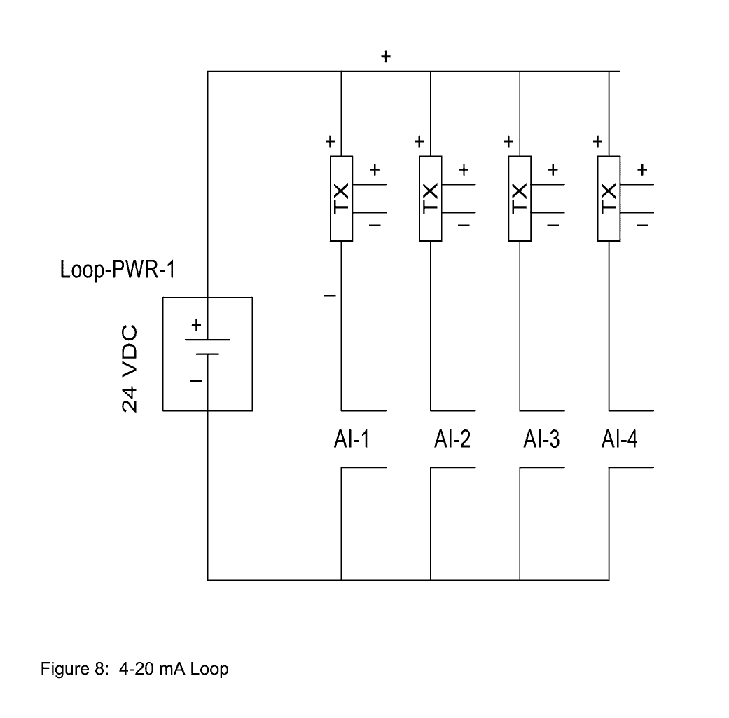

FIG. 7 shows the pipe layout with reference to the sensor position to obtain the optimum results in relation to the downstream and up-flow path. The upstream is the incoming flow from the supply. The sensor must be a minimum of 24×the pipe diameter from the pipe elbow, while the downstream must be 5×the pipe diameter before the next flow disturbance (elbow) and the layout is typical for each floor.

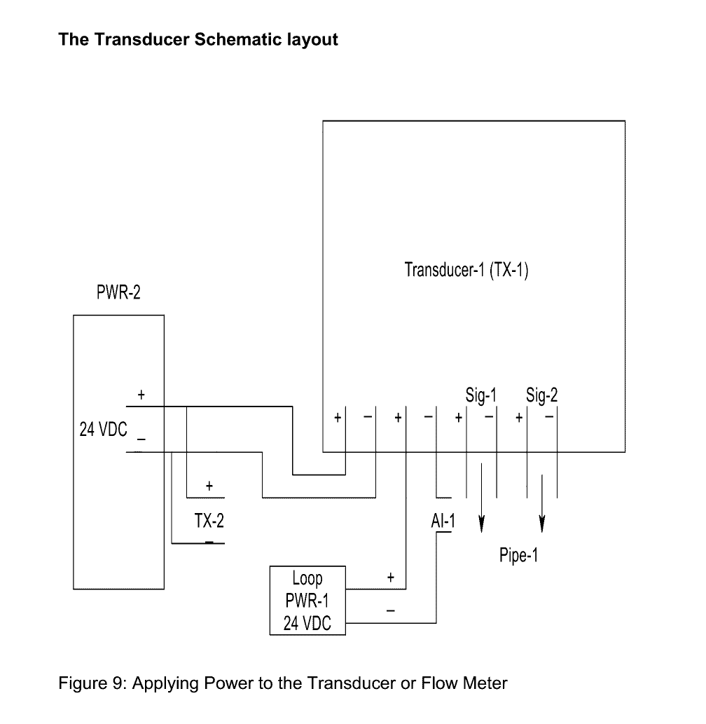

FIG. 8 shows the flow meter/transducers being powered from a common power supply and the analog (Al) signals are going to the PLC to be processed. The ultrasonic transducers are loop powered clamp-on flow meters suitable for measuring domestic water with minimum particle. This 4-20 mA loop is powered from one common supply (loop PWR-1). The negative leg of the power supply is common to all the Als. The analog signals provide the field signal to the PLC for processing.

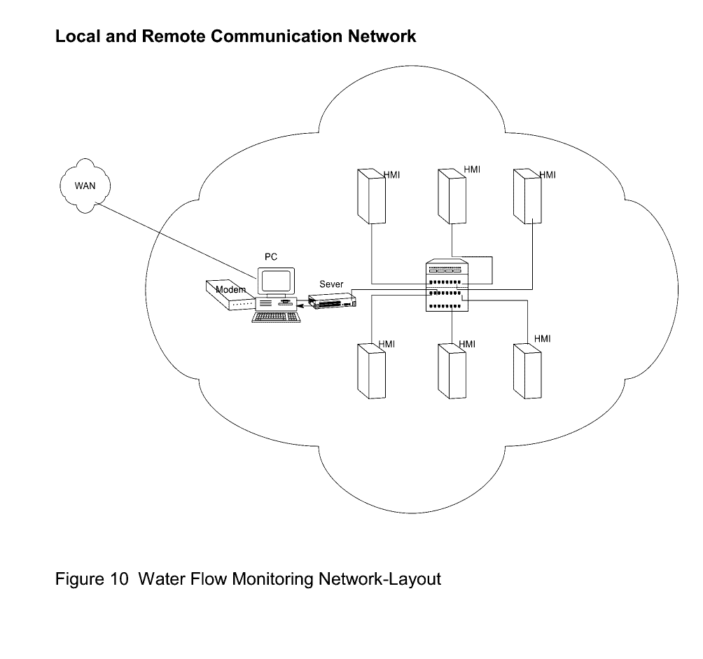

In FIG. 9 shows the transducer (flow meter) using two different power supplies, namely PWR-1 and PWR-2. PWR-1 is used to provide power for the 2-wire loop, while PWR-2 is used to provide power to Transducer. The signal Sig-1 & Sig-2 are going to the pipe risers. The Al is the analog signal 4-20 mA going to the PLC to be processed.

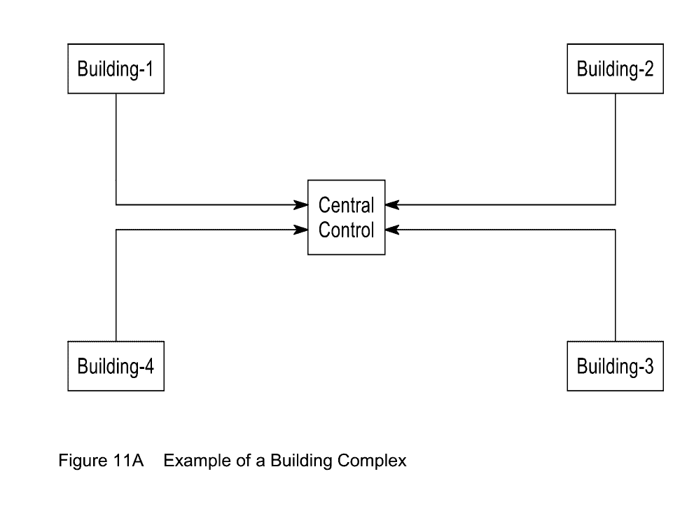

FIG. 10 shows wide area network (WAN) that will give one global access to the monitoring process. In order to monitor the process, each transducer will be assigned to Internationalized Domain Names (IDN). This IDN will provide browser support for navigating to URLs.

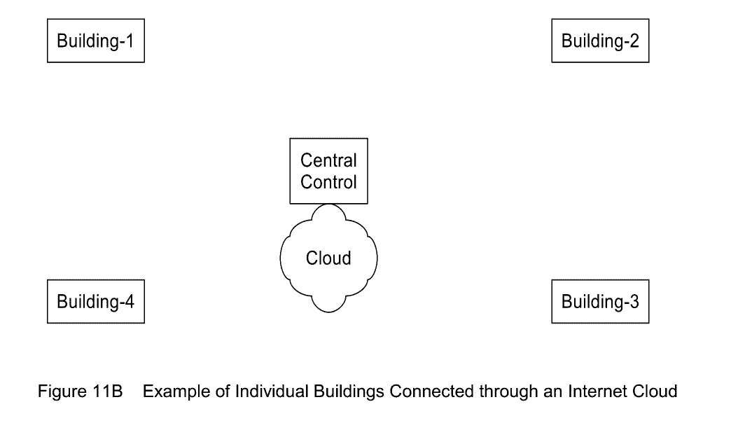

FIG. 11A shows a typical building complex with 4 independent buildings, namely Building-1, Building-2, Building-3, and Building-4. These buildings are tied together to an Ethernet network for centralized monitoring.

FIG. 11B shows 4 independent buildings being monitored by a Cloud Internet process. Building-1, Building-2, Building-3, and Building-4 are tied to a central control through internet. Therefore, from the internet cloud, one can monitor all 4 buildings.

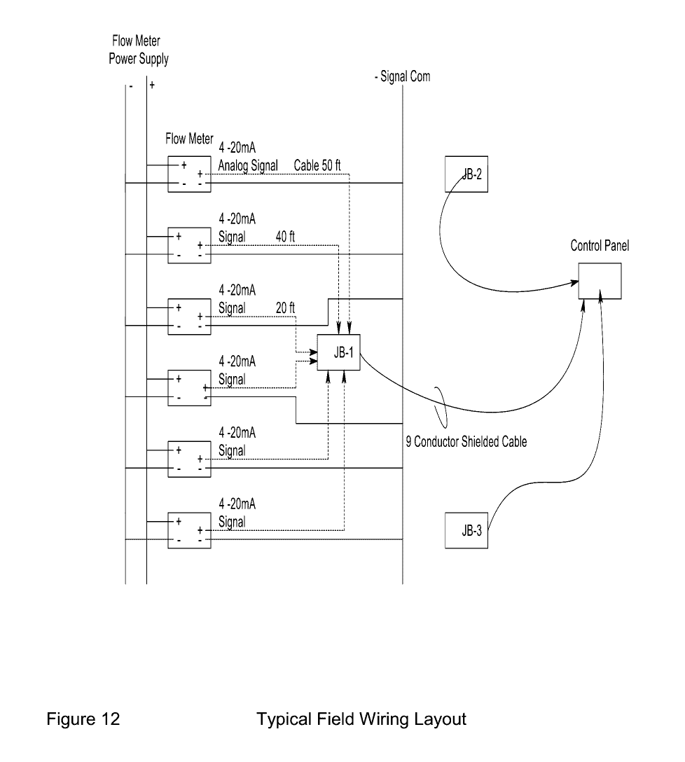

FIG. 12 shows how multiple flow meters are connected to a common power supply with the 4-20 mA signal going to a common junction box (JB-1). The signal is fed from JB-1 to the PLC controller to be processed. JB-2 and JB-3 is an extension of the same process described for JB-1.

According to the measuring system in present embodiment, it is possible to carry out measurement and monitoring in various modes.

In case where the flow meter cannot clamp on the domestic water pipe directly, then the sensors are attached with electrical cable to carry the signal to the flow meter. The sensors are used to sense the flow of water in an up stream and down stream flow path to provide the maximum sensitivity and optimum gap for the up steam and down stream sensors. Furthermore, to achieve the best sensitivity, one must apply ultrasonic jelly to a clean area for the pipe riser before clamping the non-intrusive sensors on the pipe. The signal from the flowmeter is sent is to the PLC controller to be processed. In case where the flowmeter can clamp on to a clean service directly, then this option is preferred because it is more cost effective due to an easy installation, and without the external sensors.

The monitoring process includes:
a) The scaling of 4-20 mA signal that goes from 3277-16384 to represent an input signal of 14 bits.
b) The scaled process is described in the detailed description of FIG. 2. The decision-making process of determining a given flow condition that is considered a leak, would be a condition where there is a non-flow condition over a given period. Therefore, to achieve the desired results, a PLC program in conjunction with HMI and a webserver is used to meet the required conditions.

### SUMMARY OF THE INVENTION

It is an object of this present invention to provide a solution to unwanted water flow and leaks in multi-resident apartment buildings with the use of a monitoring system. To obtain the object as described above, a flow meter is used in conjunction with PLC+HMI to display water flow and leaks through a web server and cellular text messages. This water monitoring system for a multi-resident high rise building comprises of a non-intrusive flow meter and sensors scaled at 4-20 mA. This invention uses Programmable Logic Controller (PLC) with Human to Man Interface (HMI) to measure water flow rate, flow duration, and total flow over a given period. If the flow is continuous over a given period without decreasing to a non-flow condition, then this condition is considered a leak, and a cellular text message will be sent to the stakeholder to indicate the floor or floor riser where the leak is occurring. The water monitoring system will display subsequent leaks locally while the previous condition for the message is still active in the PLC communication log.

The water monitoring system will monitor water flow and leaks in a multiple pipe arrangement comprising of one flow meter on each water pipe supply to a floor horizontally or vertical riser. The HMI process is web base and therefore allows this system to do live trending of the scaled integer valves locally and remotely. This water monitoring process is comprised of a PLC program with supervisory logic to provide a text message to the stakeholder if the signal from the flow meter to the controller is absent for more than a given period, for example 24 hours.

In addition, the water monitoring system comprises of a PLC program which provides local and remote average water flow per day for each floor or floor riser with the means of tracking water leaks and un-wanted flow from overflowing toilets and toilets where the flapper valves fail to re-seat after flushing. The PLC+HMI programming is designed to incorporate a single building or a group of high rise buildings in one complex on a data bus network. This invention is comprised of a PLC+HMI to monitor several buildings locally or remotely using, Modbus TCP, and IP into a common wide area network hub for central monitoring and display. The water monitoring system is comprised of a PLC+HMI program to integrate several flow meter signals through programmed subroutine with time division sequencing to sample scaled integer values from water flow over a given period, for example 24 hours for local and remote trending.

The problem of water leaks or unwanted flow, such as an overflowing toilet can be very costly if undetected. In a multi-resident high rise building there is no proven cost effective way to monitor water leaks. For example, it is not cost effective to monitor individual appliances and individual units. In addition, most high rise buildings do not have any means of monitoring water leaks in reference to early warning. On the other hand, this invention will monitor each floor or floor riser which will significantly reduce the cost, because only one flow meter is required per floor. Finally, no plumbing is required because it is a non-intrusive ultrasonic clamp-on flow meter.

1. A water monitoring system for a multi-resident high rise building comprising a non-intrusive flow meter and sensors, a webserver, a Programmable Logic Controller (PLC) with Human to Man Interface (HMI) with the means for measuring non flow, flow rate, flow duration, and total water flow over a given period, and means for sending a cellular text message.

2. The water monitoring system cited in claim 1, comprising a PLC controller with indicating lights to annunciate locally the floor or floor riser that the leak is on.

3. The water monitoring system cited in claim 1 comprising Ajax-Java Script software to poll data from the PLC to a webserver.

4. The water monitoring system cited in claim 1 comprising the means of sending a cellular text message to the stakeholder if there is a leak.

5. The water monitoring system cited in claim 1 comprising of one flow meter on each water pipe supply to a floor horizontally or through a vertical water supply pipe riser.

6. The water monitoring system cited in claim 1 comprising a PLC program with supervisory ladder logic for sending text messages to the stakeholder.

7. The water monitoring system cited in claim 5 comprising the means for tracking water leaks and un-wanted flow from over-flowing toilets and toilets where the flapper valves fail to re-seat after flushing.

8. The water monitoring system cited in claim 1 comprising a means for incorporating a single building or a group of high rise buildings in one complex on a data bus network.

9. The water monitoring system cited in claim 1 comprising Modbus TCP, and IP into a common wide area network hub for central monitoring and display.

10. The water monitoring system cited in claim 9 comprising the means for integrating several flow meter signals, programmed subroutine with time division sequencing with the means for sampling scaled integer values from water flow over a given period, for example, 24 hours for local and remote trending.
